(19) United States
(12) Patent Application Publication
(10) Pub. No.: US 2026/0266115 A1
(43) Pub. Date: Sep. 10, 2026

(54) DOOR CABLE TENSIONING DEVICE

(71) Applicant: Edward Glassen, Clark, NJ (US)

(72) Inventor: Edward Glassen, Clark, NJ (US)

(21) Appl. No.: 19/069,909

(22) Filed: Mar. 4, 2025

(51) Int. Cl. E05F 1/10; B60P 1/43

(52) U.S. Cl. CPC E05F 1/10; B60P 1/435; E05Y 2201/49; E05Y 2201/499; E05Y 2201/654; E05Y 2201/668

(57) ABSTRACT

A door cable tensioning device includes a cargo trailer and a door which is hingedly coupled to the cargo trailer. A pulley is coupled to the cargo trailer. The pulley is biased to rotate in a first direction and the pulley is rotatable in a second direction. A cable is coupled between the pulley and the door. The pulley urges the door into the closed position when the pulley is biased to rotate in the first direction. A bracket is coupled to the door and a bolt extends laterally away from the bracket. A tensioning spring has a coiled portion and an arm portion. The coiled portion is wrapped around the bolt and the arm portion presses against the cable. The arm portion retains tension on the cable to inhibit the cable from unwrapping from the pulley when the door is urged into the closed position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to door cable devices and more particularly pertains to a new door cable device for retaining tension on a door cable of a cargo trailer. The device includes a cargo trailer that has a door and a pulley that is mounted to the cargo trailer. The device includes a cable that is wrapped around the pulley and which is coupled to the door. The device includes a bracket that is coupled to the door and a bolt that extends laterally away from the bracket and a tensioning spring that is positioned around the bolt. The tensioning spring presses against the cable to retain tension on the cable thereby inhibiting the cable from unwrapping from the pulley when the door is urged into a closed position.

### (2) Description of Related Art Including Information Disclosed Under 37 CFR 1.97 and 1.98.

The prior art relates to door cable devices including: a variety of cable tensioner devices that each at least includes a bracket mounted to an overhead door and a tensioning spring attached the bracket which applies tension to a cable of the overhead door to retain tension on the cable; a variety of line tensioning devices that each at least includes a ratchet and a biasing member disposed in the ratchet and a hook that is slidably disposed in the ratchet that is biased toward the ratchet to retain tension on a line which is attached to the hook. In no instance does the prior art disclose a door cable tensioning device that includes a cargo trailer and a pulley attached to the cargo trailer and a cable extending between the pulley and a door of the trailer and a tensioning spring disposed on the door which presses on the cable to retain tension on the cable.

### BRIEF SUMMARY OF THE INVENTION

An embodiment of the disclosure meets the needs presented above by generally comprising a cargo trailer and a door which is hingedly coupled to the cargo trailer. A pulley is coupled to the cargo trailer. The pulley is biased to rotate in a first direction and the pulley is rotatable in a second direction. A cable is coupled between the pulley and the door. The pulley urges the door into the closed position when the pulley is biased to rotate in the first direction. A bracket is coupled to the door and a bolt extends laterally away from the bracket. A tensioning spring has a coiled portion and an arm portion. The coiled portion is wrapped around the bolt and the arm portion presses against the cable. The arm portion retains tension on the cable to inhibit the cable from unwrapping from the pulley when the door is urged into the closed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a door cable tensioning device according to an embodiment of the disclosure.

FIG. 2 is a perspective view of a bracket and a bolt and a tensioning spring of an embodiment of the disclosure.

FIG. 3 is a right side phantom view of a bracket and a bolt and a tensioning spring of an embodiment of the disclosure.

FIG. 4 is a front view of a pair of brackets and a pair of bolts and a pair of tensioning springs of an embodiment of the disclosure.

### DETAILED DESCRIPTION OF THE INVENTION

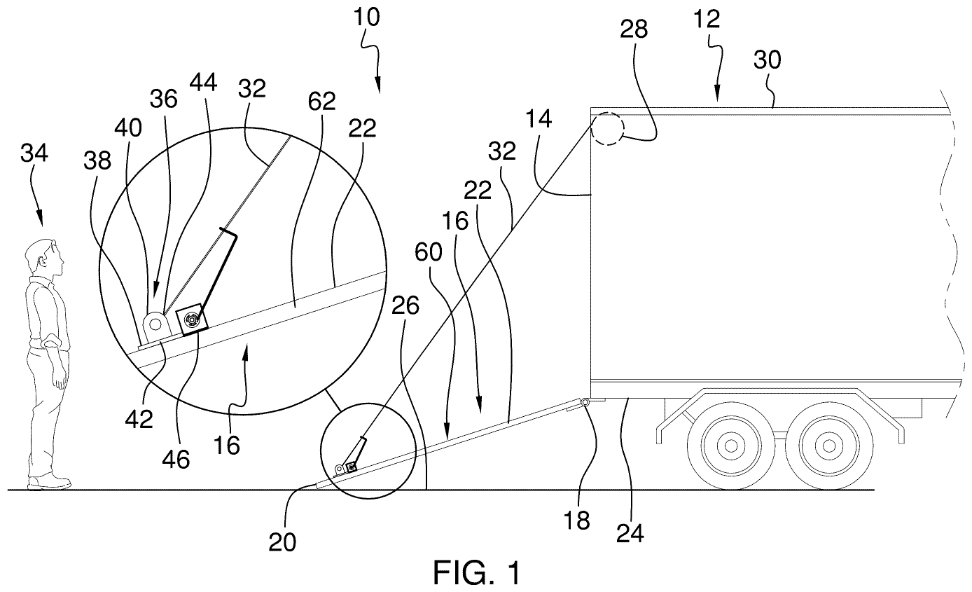

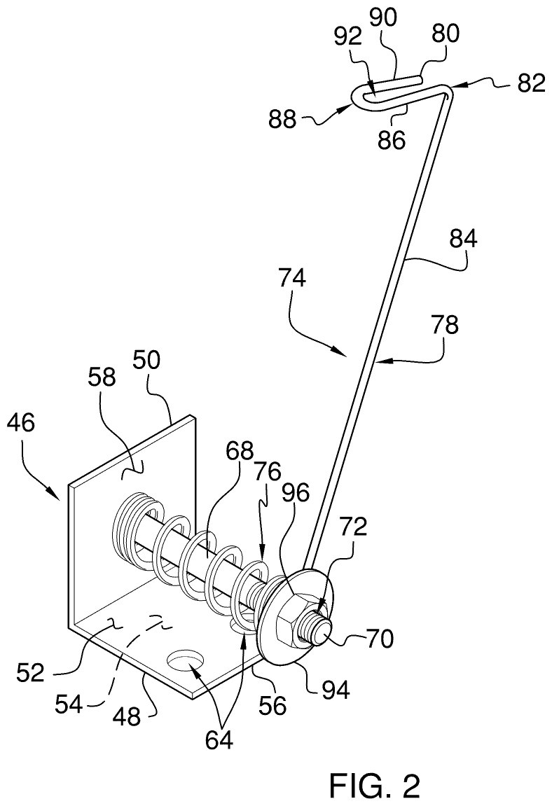

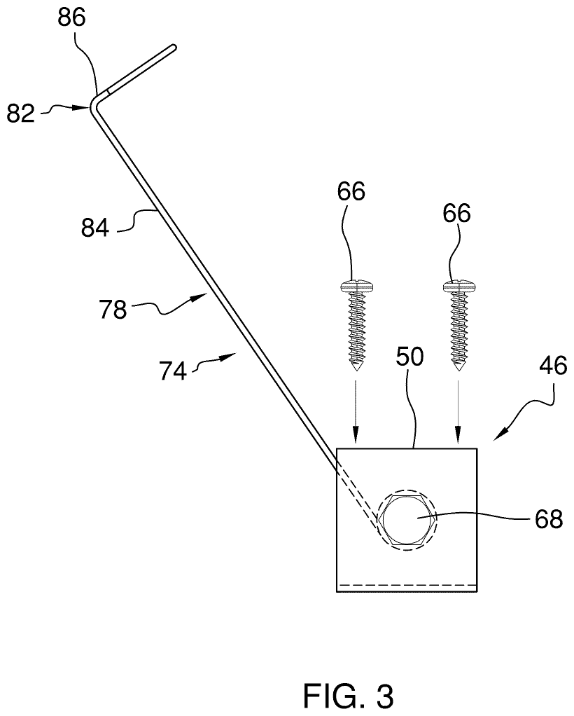

With reference now to the drawings, and in particular to FIGS. 1 through 4 thereof, a new door cable device embodying the principles and concepts of an embodiment of the disclosure and generally designated by the reference numeral 10 will be described.

As best illustrated in FIGS. 1 through 4, the door cable tensioning device 10 generally comprises a cargo trailer 12 that has a rear end 14 which is open into an interior of the cargo trailer 12. A door 16 is hingedly coupled to the cargo trailer 12 and the door 16 is positionable between an open position and a closed position. The door 16 has a lower edge 18 and an upper edge 20 and a top surface 22 extending between the lower edge 18 and the upper edge 20. The cargo trailer 12 has a floor 24 and the lower edge 18 of the door 16 is hingedly coupled to an intersection between the floor 24 and the rear end 14 of the trailer 12. Furthermore, the top surface 22 of the door 16 is oriented at a downwardly angle with the rear end 14 of the trailer 12 when the door 16 is in the open position such that the top surface 22 extends between the rear end 14 and a support surface 26. The top surface 22 of the door 16 rests against the rear end 14 of the cargo trailer 12 when the door 16 is in the closed position. The cargo trailer 12 may be an enclosed cargo trailer of any conventional design that is employed for transporting motorized vehicles, for example.

A pulley 28 is provided and the pulley 28 is coupled to the cargo trailer 12. The cargo trailer 12 has a ceiling 30 and the pulley 28 is positioned adjacent to the ceiling 30. Additionally, the pulley 28 is oriented to extend laterally across the rear end 14 of the cargo trailer 12. The pulley 28 is biased to rotate in a first direction and the pulley 28 is rotatable in a second direction.

A cable 32 is coupled between the pulley 28 and the door 16. The pulley 28 urges the door 16 into the closed position when the pulley 28 is biased to rotate in the first direction. Furthermore, the pulley 28 is biased to rotate in the first direction with a spring force that is less than a weight of the door 16. The pulley 28 assists a user 34 with lifting the door 16 upwardly from the support surface 26 to position the door 16 in the closed position. Additionally, the pulley 28 may be a spring loaded pulley that is commonly associated with overhead doors. The cable 32 may be a steel cable or other type of resilient cable commonly associated with overhead doors. The cable 32 may be one of a pair of cables 32 that are each attached to opposite sides of the door 16.

A coupler 36 is provided which comprises a base portion 38 and a pin portion 40 extending upwardly from the base portion 38. The base portion 38 has a bottom surface 42 and the bottom surface 42 is coupled to the top surface 22 of the door 16. The coupler 36 is located closer to the upper edge 20 of the door 16 than the lower edge 18 of the door 16. The cable 32 has a distal end 44 with respect to the pulley 28 and the distal end 44 is coupled to the pin portion 40 of the coupler 36. The coupler 36 may be one of a pair of couplers 36 that are each positioned on opposite sides of the door 16 from each other and each of the pair of cables 32 may be coupled to a respective coupler 36.

A bracket 46 is coupled to the door 16 and the bracket 46 has a first section 48 which is oriented at an angle with a second section 50. The first section 48 has a topmost surface 52 and a bottommost surface 54 and a distal edge 56 with respect to the second section 50. The second section 50 has a lateral surface 58 and the lateral surface 58 lies on a plane which is oriented perpendicular to the topmost surface 52. The bottommost surface 54 of the first section 48 lies on the top surface 22 of the door 16. The first section 48 is positioned adjacent to the base portion 38 of the coupler 36 and the bracket 46 is located between the coupler 36 and the lower edge 18 of the door 16. Furthermore, the bracket 46 is oriented such that the first section 48 is directed toward a center 60 of the door 16 and the second section 50 is directed toward an outer edge 62 of the door 16.

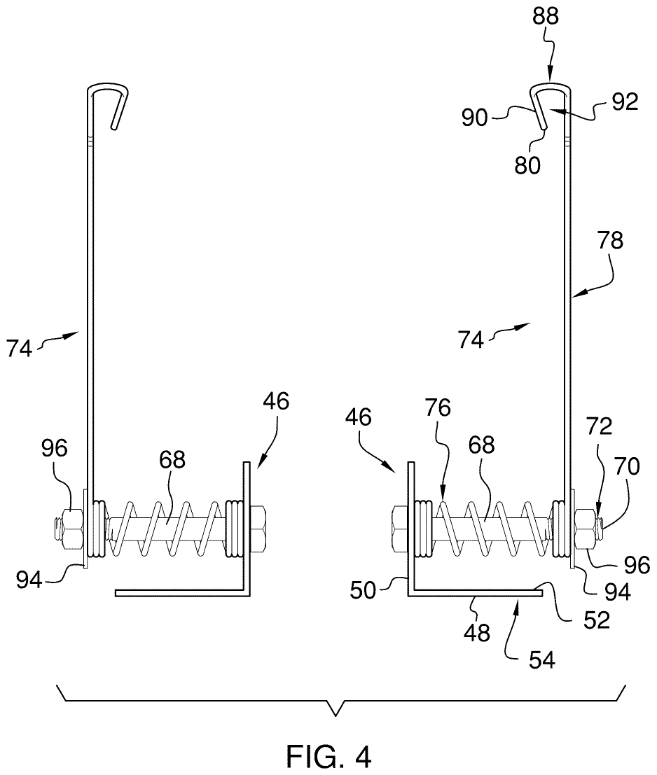

The first section 48 has a pair of holes 64 each extending through the topmost surface 52 and the bottommost surface 54. Each hole 64 of the pair of holes 64 is positioned closer to the distal edge 56 of the first section 48 than the lateral surface 58 of the second section 50. Additionally, the pair of holes 64 is spaced apart from each other and is distributed along the distal edge 56. A pair of fasteners 66 each extends through a respective hole 64 in the first section 48 of the bracket 46 and each fastener 66 of the pair of fasteners 66 engages the door 16 for retaining the bracket 46 on the door 16. As is shown in FIG. 4, the bracket 46 may be one of a pair of brackets 46 which is each positioned on opposite sides of the door 16 from each other.

A bolt 68 is provided and the bolt 68 is coupled to the bracket 46. The bolt 68 extends laterally away from the bracket 46 and the bolt 68 is coupled to the second section 50 of the bracket 46. The bolt 68 is oriented perpendicular to the lateral surface 58 of the second section 50. The bolt 68 is centrally located on the second section 50. The bolt 68 has a distal end 70 with respect to the lateral surface 58 of the second section 50 and the bolt 68 has threads 72 extending from the distal end 70 of the bolt 68 toward the lateral surface 58 of the second section 50. Additionally, the bolt 68 has a length that is greater than a length of the first section 48 of the bracket 46 and the distal end 70 of the bolt 68 is spaced outwardly the distal edge 56 of the first section 48. As is shown in FIG. 4, the bolt 68 may be one of a pair of bolts 68 which is each coupled to a respective one of the pair of brackets 46.

A tensioning spring 74 is provided and the tensioning spring 74 is disposed on the bolt 68. The tensioning spring 74 has a coiled portion 76 and an arm portion 78; the coiled portion 76 is wrapped around the bolt 68 and the arm portion 78 is oriented perpendicular to the bolt 68. The arm portion 78 presses against the cable 32 and the coiled portion 76 biases the arm portion 78 to urge the cable 32 toward the door 16 to retain tension on the cable 32. The arm portion 78 inhibits the cable 32 from unwrapping from the pulley 28 when the door 16 is urged into the closed position. Furthermore, the tensioning spring 74 inhibits the user 34 from having to replace the cable 32 onto the pulley 28 when the cable 32 becomes unwrapped from the pulley 28. As is shown in FIG. 4, the tensioning spring 74 may be one of a pair of tensioning springs 74 that is each disposed on a respective one of the pair of bolts 68.

The arm portion 78 has a distal end 80 of the arm portion 78 with respect to the coiled portion 76. The arm portion 78 has a first bend 82 which is positioned closer to the distal end 80 of the arm portion 78 than the coiled portion 76. The first bend 82 defines a primary section 84 of the arm portion 78 which is perpendicular to a secondary section 86 of the arm portion 78 and the primary section 84 intersects the coiled portion 76. The arm portion 78 has a second bend 88 which is located between the first bend 82 and the distal end 80 of the arm portion 78. The second bend 88 defines a tertiary section 90 of the arm portion 78 and the tertiary section 90 is aligned with the secondary section 86. The tertiary section 90 defines a cable space 92 between the tertiary section 90 and the secondary section 86. The tertiary section 90 angles toward the secondary section 86 and the distal end 80 of the arm portion 78 is associated with the tertiary section 90. The cable 32 extends through the cable space 92 and the tertiary section 90 retains the cable 32 in the cable space 92. Additionally, the arm portion 78 is directed toward the rear end 14 of the cargo trailer 12 when the door 16 is in the open position.

A washer 94 is positioned on the bolt 68 and the washer 94 abuts the coiled portion 76 of the tensioning spring 74. Additionally, the washer 94 is spaced from the distal end of the bolt 68. As is shown in FIG. 4, the washer 94 may be one of a pair of washers 94 that is each positioned on a respective one of the pair of bolts 68. A nut 96 is threaded onto the threads 72 of the bolt 68 and the nut 96 compresses the washer 94 against the coiled portion 76 of the tensioning spring 74. As is shown in FIG. 4, the nut 96 may be one of a pair of nuts 96 that is each threaded onto a respective one of the pair of bolts 68.

In use, the arm portion 78 of the tensioning spring 74 presses downwardly on the cable 32 to retain tension on the cable 32 at all times. It is a common occurrence that the cable 32 will lose tension when the door 16 is lifted into the closed position at a velocity that is quicker than the pulley 28 can rotate in the first direction when can cause the cable 32 to unwrap from the pulley 28. This requires the user 34 to spend a significant amount of time to reposition the cable 32 around the pulley 28 to restore normal function to the door 16. The tensioning spring 74 ensures that the cable 32 is under constant tension regardless of the rate at which the door 16 is lifted into the closed position to ensure normal function of the door 16 at all times. Furthermore, the coiled portion 76 of the tensioning spring 74 has a spring force that is sufficient to overcome the lack of tension in the cable 32 when the door 16 is rapidly lifted into the closed position to ensure that the pulley 28 is able to take up any potential slack in the cable 32 while the door 16 is being urged into the closed position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A door cable tensioning device for retaining tension on a door cable of a trailer, said device comprising:
a cargo trailer;
a door being hingedly coupled to said cargo trailer, said door being positionable between an open position and a closed position;
a pulley being coupled to said cargo trailer, said pulley being biased to rotate in a first direction, said pulley being rotatable in a second direction;
a cable being coupled between said pulley and said door, said pulley urging said door into said closed position when said pulley is biased to rotate in said first direction, said pulley being biased to rotate in said first direction with a spring force being less than a weight of said door wherein said pulley is configured to assist a user with lifting said door upwardly from the support surface to position said door in said closed position, said pulley rotating in said second direction when said door is urged into said open position;
a bracket being coupled to said door;
a bolt being coupled to said bracket, said bolt extending laterally away from said bracket; and
a tensioning spring being disposed on said bolt, said tensioning spring having a coiled portion and an arm portion, said coiled portion being wrapped around said bolt, said arm portion being oriented perpendicular to said bolt, said arm portion pressing against said cable, said coiled portion biasing said arm portion to urge said cable toward said door to retain tension on said cable, said arm portion inhibiting said cable from unwrapping from said pulley when said door is urged into said closed position wherein said tensioning spring is configured to inhibit the user from having to replace said cable onto said pulley.

2. The door cable tensioning device according to claim 1, further comprising:
said cargo trailer having a rear end;
said rear end being open into an interior of said cargo trailer;
said cargo trailer having a floor;
said door having a lower edge and an upper edge and a top surface extending between said lower edge and said upper edge;
said lower edge being hingedly coupled to an intersection between said floor and said rear end of said trailer; and
said top surface being oriented at a downwardly angle with said rear end of said trailer when said door is in said open position wherein said top surface is configured to extend between said rear end and a support surface, said top surface resting against said rear end when said door is in said closed position.

3. The door cable tensioning device according to claim 1, further comprising:
said door having a top surface and a lower edge and an upper edge;
a coupler comprising a base portion and a pin portion extending upwardly from said base portion;
said base portion having a bottom surface;
said bottom surface being coupled to said top surface of said door;
said coupler being located closer to said upper edge of said door than said lower edge of said door;
said cable having a distal end with respect to said pulley; and
said distal end being coupled to said pin portion of said coupler.

4. The door cable tensioning device according to claim 3, further comprising:
said bracket having a first section being oriented at an angle with a second section;
said first section having a topmost surface and a bottommost surface and a distal edge with respect to said second section;
said second section having a lateral surface;
said lateral surface lying on a plane being oriented perpendicular to said topmost surface;
said bottommost surface of said first section lying on said top surface of said door;
said first section being positioned adjacent to said base portion of said coupler; and
said bracket being located between said coupler and said lower edge of said door.

5. The door cable tensioning device according to claim 4, further comprising:
said first section having a pair of holes each extending through said topmost surface and said bottommost surface;
each hole of said pair of holes being positioned closer to said distal edge of said first section than said lateral surface of said second section; and
said pair of holes being spaced apart from each other and being distributed along said distal edge.

6. The door cable tensioning device according to claim 5, further comprising:
a pair of fasteners;
each fastener of said pair of fasteners extending through a respective hole in said first section of said bracket; and
each fastener of said pair of fasteners engaging said door for retaining said bracket on said door.

7. The door cable tensioning device according to claim 4, further comprising:
said bolt being coupled to said second section of said bracket;
said bolt being oriented perpendicular to said lateral surface of said second section; and
said bolt being centrally located on said second section.

8. The door cable tensioning device according to claim 4, further comprising:
said bolt having a distal end with respect to said lateral surface of said second section; and
said bolt having threads extending from said distal end of said bolt toward said lateral surface of said second section.

9. The door cable tensioning device according to claim 8, further comprising:
said bolt having a length being greater than a length of said first section of said bracket; and
said distal end of said bolt being spaced outwardly said distal edge of said first section.

10. The door cable tensioning device according to claim 1, further comprising:
said arm portion having a distal end of said arm portion with respect to said coiled portion;
said arm portion having a first bend being positioned closer to said distal end of said arm portion than said coiled portion;
said first bend defining a primary section of said arm portion being perpendicular to a secondary section of said arm portion; and
said primary section intersecting said coiled portion.

11. The door cable tensioning device according to claim 10, further comprising:
said arm portion having a second bend being located between said first bend and said distal end of said arm portion; and
said second bend defining a tertiary section of said arm portion.

12. The door cable tensioning device according to claim 11, further comprising:
said tertiary section being aligned with said secondary section; and
said tertiary section defining a cable space between said tertiary section and said secondary section.

13. The door cable tensioning device according to claim 11, further comprising said tertiary section angling toward said secondary section.

14. The door cable tensioning device according to claim 11, further comprising said distal end of said arm portion being associated with said tertiary section.

15. The door cable tensioning device according to claim 12, further comprising said cable extending through said cable space.

16. The device according to claim 15, further comprising said tertiary section retaining said cable in said cable space.

17. The door cable tensioning device according to claim 1, further comprising:
said cargo trailer having a rear end; and
said arm portion being directed toward said rear end of said cargo trailer when said door is in said open position.

18. The door cable tensioning device according to claim 8, further comprising:
a washer being positioned on said bolt;
said washer abutting said coiled portion of said tensioning spring;
said washer being spaced from said distal end of said bolt;
a nut being threaded onto said threads of said bolt; and
said nut compressing said washer against said coiled portion of said tensioning spring.

19. A door cable tensioning device for retaining tension on a door cable of a trailer, said device comprising:
a cargo trailer having a rear end, said rear end being open into an interior of said cargo trailer;
a door being hingedly coupled to said cargo trailer, said door being positionable between an open position and a closed position, said door having a lower edge and an upper edge and a top surface extending between said lower edge and said upper edge, said cargo trailer having a floor, said lower edge being hingedly coupled to an intersection between said floor and said rear end of said trailer, said top surface being oriented at a downwardly angle with said rear end of said trailer when said door is in said open position wherein said top surface is configured to extend between said rear end and a support surface, said top surface resting against said rear end when said door is in said closed position;
a pulley being coupled to said cargo trailer, said cargo trailer having a ceiling, said pulley being positioned adjacent to said ceiling, said pulley being biased to rotate in a first direction, said pulley being rotatable in a second direction;
a cable being coupled between said pulley and said door, said pulley urging said door into said closed position when said pulley is biased to rotate in said first direction, said pulley being biased to rotate in said first direction with a spring force being less than a weight of said door wherein said pulley is configured to assist a user with lifting said door upwardly from the support surface to position said door in said closed position, said pulley rotating in said second direction when said door is urged into said open position;
a coupler comprising a base portion and a pin portion extending upwardly from said base portion, said base portion having a bottom surface, said bottom surface being coupled to said top surface of said door, said coupler being located closer to said upper edge of said door than said lower edge of said door, said cable having a distal end with respect to said pulley, said distal end being coupled to said pin portion of said coupler;
a bracket being coupled to said door, said bracket having a first section being oriented at an angle with a second section, said first section having a topmost surface and a bottommost surface and a distal edge with respect to said second section, said second section having a lateral surface, said lateral surface lying on a plane being oriented perpendicular to said topmost surface, said bottommost surface of said first section lying on said top surface of said door, said first section being positioned adjacent to said base portion of said coupler, said bracket being located between said coupler and said lower edge of said door, said first section having a pair of holes each extending through said topmost surface and said bottommost surface, each hole of said pair of holes being positioned closer to said distal edge of said first section than said lateral surface of said second section, said pair of holes being spaced apart from each other and being distributed along said distal edge;
a pair of fasteners, each fastener of said pair of fasteners extending through a respective hole in said first section of said bracket, each fastener of said pair of fasteners engaging said door for retaining said bracket on said door;
a bolt being coupled to said bracket, said bolt extending laterally away from said bracket, said bolt being coupled to said second section of said bracket, said bolt being oriented perpendicular to said lateral surface of said second section, said bolt being centrally located on said second section, said bolt having a distal end with respect to said lateral surface of said second section, said bolt having threads extending from said distal end of said bolt toward said lateral surface of said second section, said bolt having a length being greater than a length of said first section of said bracket, said distal end of said bolt being spaced outwardly said distal edge of said first section;
a tensioning spring being disposed on said bolt, said tensioning spring having a coiled portion and an arm portion, said coiled portion being wrapped around said bolt, said arm portion being oriented perpendicular to said bolt, said arm portion pressing against said cable, said coiled portion biasing said arm portion to urge said cable toward said door to retain tension on said cable, said arm portion inhibiting said cable from unwrapping from said pulley when said door is urged into said closed position wherein said tensioning spring is configured to inhibit the user from having to replace said cable onto said pulley, said arm portion having a distal end of said arm portion with respect to said coiled portion, said arm portion having a first bend being positioned closer to said distal end of said arm portion than said coiled portion, said first bend defining a primary section of said arm portion being perpendicular to a secondary section of said arm portion, said primary section intersecting said coiled portion, said arm portion having a second bend being located between said first bend and said distal end of said arm portion, said second bend defining a tertiary section of said arm portion, said tertiary section being aligned with said secondary section, said tertiary section defining a cable space between said tertiary section and said secondary section, said tertiary section angling toward said secondary section, said distal end of said arm portion being associated with said tertiary section, said cable extending through said cable space, said tertiary section retaining said cable in said cable space, said arm portion being directed toward said rear end of said cargo trailer when said door is in said open position;
a washer being positioned on said bolt, said washer abutting said coiled portion of said tensioning spring, said washer being spaced from said distal end of said bolt; and
a nut being threaded onto said threads of said bolt, said nut compressing said washer against said coiled portion of said tensioning spring.
